(19) United States
(12) Patent Application Publication
(10) Pub. No.: US 2008/0134539 A1
(43) Pub. Date: Jun. 12, 2008

(54) Apparatus and Method for Grain Treatment

(76) Inventors: Vladimir Prokhorets, Ganey Aviv (IL); Edward Brook-Levinson, Petah Tikva (IL); Mark Geller, Kadima (IL)

Correspondence Address: NATH & ASSOCIATES, 112 South West Street, Alexandria, VA, 22314, US

(21) Appl. No.: 11/794,161

(22) PCT Filed: Sep. 22, 2005
(86) PCT No.: PCT/IL05/01012

§ 371 Date: Jan. 9, 2008

(30) Foreign Application Priority Data
Dec. 23, 2004 (IL) 165967

(51) Int. Cl. F26B 5/08

(52) U.S. Cl. 34/312; 34/443

(57) ABSTRACT

An apparatus and method for treatment of raw grain particles for conversion of the grain nutrients to the condition in which they are readily digestible by a living organism are provided. The apparatus includes a mixture chamber in which the raw grain particles are fed, a gas heat source, and a blower fan for providing a hot gas low through two or more gas ducts connecting the gas heat source to the mixture chamber. The gas ducts are equipped with nozzles for providing two or more hot gas streams configured for spinning particles of the raw grain and circulating the particles along an inner surface of the chamber

### FIELD OF THE INVENTION

This invention relates to an apparatus and method for material treatment by heated air stream, and in particular, for treating agricultural grains for more efficient usage thereof as feed products for feeding a living organism.

### BACKGROUND OF THE INVENTION

The grains used for animal feed may contain up to 75% of starch, serving as an energy source in animals' diet. However, the digestion of starch is time consuming, and usually never complete because enzymes, which hydrolyse sucrose and starch to simple sugars readily absorbed in the digestive tract, are not present in sufficient amounts in the digestive tract. Nevertheless, assimilation of die grain food can be essentially enhanced if the grain is subjected to heat treatment prior to feeding the grain to animals, providing, inter alia, conversion of the starch into dextrin and sugars.

Protein is also an important factor when planning a balanced diet for animals. Cereal grains such as wheat, ray, barley, corn, millet, sorghum and rice are widely grown throughout the world, since these grains contain four major protein groups such as albumins, globulins, gliadins and glutenins or corresponding proteins. A soybean crop is also grown, because of its abundance in proteins. For example, such soybean proteins as globulins and albumins are composed of many essential amino acids such as lysine, leucine, arginine, isoleucine, glycine, tyrosine, phenylalaninie, tryptophan, histidine, valine and the like. In particular, it has been found that soybeans are valuable as a supplement to diets containing wheat flour due to the fact that the soybean proteins contain 4 to 17 times as much essential amino acids as wheat proteins.

Unfortunately, some species of animals, e.g., permanent calves, are allergic to regular soybeans or more particularly, to such components as glycin and β-conglycinin. Moreover, many cereal grains also contain proteins that have been shown to act as inhibitors of enzymes, e.g., amylase inhibitors and trypsin inhibitors. In particular, soybeans contain several deleterious components which include different protease inhibitors, generally called trypsin inhibitors. It is well established that raw soybeans interfere with the digestion of proteins in the intestine of poultry. Raw soybean meal may also cause excessive enlargement of the pancreas of growing animals. The pancreas is stimulated by trypsin inhibitors to increase secretion of pancreatic enzymes with a high content of cystine creating indirectly a methionine deficiency. Thus, growth inhibition of animals may be a result of this methionine deficiency.

Effects of raw soybean meal on growth inhibition of poultry could be partially overcome by supplementing the diet with methionine, threonine and valine. Moreover, the allergic components as well as trypsin inhibitors can first be inactivated before any soybean product can be ingested by the animals. Thus, cereal grains and especially soybeans can be treated for minimizing the adverse effects caused by the allergic components and trypsin inhibitors, and thereby placing them in a condition where the grains may be usable as a food product for poultry and livestock.

One of the conventional approaches for destruction of the trypsin inhibitors in soybeans is used in the process of soy oil production, during which the grain is ground and treated with petrol ether for the process of oil extraction. The remaining part of the treated grain after the oil extraction is referred to as “soybean meal”, since it is usually used for animal feeding. The soybean meal contains sufficient amounts of proteins and amino acids, however substantially less percentage of fat. Hence, the soybean meal usually lacks energy, since the source of energy is oil rather than proteins. The lack of energy can be compensated by adding oil to the feed (approximately 55 kg of oil per one ton of feed). As a result of such treatment, the energetic value of the soybean may drop, for example, from 3600 Kcal/kg (raw soybean) to 2240 Kcal/kg (soybean meal).

Heat treatment of raw grains is also known to be used for enhancing the grains' effectiveness in developing the nutrients required by poultry and livestock. Thus, heat treatment of grains can modify both its physical and chemical characteristics (see, for example, “Evaluation of Soybean Meal Determines Adequacy of Heat Treatment,” by P. Volna, et al. published on the Internet site

http://www.asa-europe.org/pdf/evaluation.pdf).

Although the treatment of exposing the grains to high temperature can inactivate the allergic components and trypsin inhibitors and facilitate the starch-to-dextrin conversion process, it can also destroy some of the valuable proteins which have important nutritional properties. Therefore, particular constraints are usually imposed on the technique and parameters of the grain treatment, such as temperature, humidity, duration of treatment, etc. to suffice for the nutrients of the grain to be processed to a state where they are more readily digested by poultry and livestock.

Various heat treatment techniques are known in the art. One of such techniques is based on the extrusion process that includes heat treatment of the grain by means of a revolving screw through a die head opening. The high temperature in the extrusion chamber and friction in the screw generate rapid pressure decrease on the exit of the die that changes the cell structure and organelles (see, for example, an article of P. Chaluaborty, “Extrusion Technology in Food Processing,” published on the Internet site:

http://www.pfionline.com/features/processing/procl/procl.html).

Common types of such equipment are high temperature and short time expanders and extruders which can be obtained, for example, from Extru-Tech, Inc.

(http://www.extru-techinc.com).

Another known technique for grain treatment is based on the fluidization phenomenon. According to this technique, a layer of bulky product is placed on an air or gas permeable grid that is crossed by the corresponding air or gas flow. When the flow is passed upwards through the material, the pressure loss in the gas increases with increasing gas flow, due to frictional resistance. A point is reached when the upward drag force exerted by the fluid on the particles of the material is equal to the apparent weight of the particles. At this point, the particles are lifted by the flow, the separation of the particles increases and the material becomes fluidized. The grid supporting the fluidizable product and enabling the uniform and homogeneous air or gas-flow distribution is usually called “bedplate”, the product-layer “bed” and the whole system is a “fluid-bed”.

An example of a fluidized bed treating apparatus for treating such particulate material as grain products is disclosed in U.S. Pat. No. 4,419,834 to John F. Scott. The apparatus utilizes heated air to effect elevation of the temperature of the particulate grain material to a predetermined temperature whereby the available nutrients will be converted or transformed to a condition or status where they are more readily and fully digestible by livestock. The apparatus includes a closed chamber provided with a perforated bedplate across which the grain products are caused to traverse while concurrently effecting a flow of heated air through the perforated plate to effect heating the grain products.

Another example of fluidized bed treating apparatus is described in U.S. Pat. No. 5,161,315 to Long, in which a fluidizing bedplate is formed with apertures of a conical configuration. The apertures are formed with walls divergent from an exit end at an angle in the range of 25-45 degrees with a plurality of apertures formed in the bedplate in a closely spaced relationship, resulting in interaction of the airflow from the apertures to levitate the material as it is transported over the bed by the air flowing through the apertures.

A technique utilizing a Micronizing method is described in European Pat. No. 0 861 600 to Newton. According to this technique, the grain or seed is first mixed with water and vibrated in a container so as to cause the grain or seed to absorb a high percentage of the liquid (preferably between 25% and 30% by volume). Thereafter, high intensity infrared radiation is applied to grain or seed for a short period of time, which causes the gelatinisation of starches in the grain or seed.

### SUMMARY OF THE INVENTION

There is a need in the art for, and it would be useful to have, a novel apparatus and method of treatment of raw grains for the effective conversion of nutrients available in grains, to a processed condition in which they are readily and preferably fully digestible by living organisms. An example of the living organisms includes but is not limited to human beings, poultry and livestock. It would be advantageous that such conversion of the nutrients would be carried out substantially without destroying valuable proteins having important nutritional properties.

According to one embodiment of the invention, the apparatus for the treatment of raw grain particles includes a mixture chamber il which the raw grain is fed, a gas heat source, two or more gas ducts coupling the gas heat source to the mixture chamber, and a blower fan for providing a hot gas flow through the gas duct. Each duct is equipped with a nozzle for providing a corresponding hot gas stream. The gas streams are directed substantially tangentially to the inner surface of the chamber.

According to one embodiments of the invention, one of the hot gas streams is arranged in a horizontal plane, while the other hot gas stream is arranged in a vertical plane. In other words, the streams are arranged perpendicular to each other. However, when required, the angle at which one of the streams impinges on another stream can be of any predetermined value.

According to a further embodiment of the invention, the two hot gas streams are provided alternatively and directed in opposite directions. Preferably, but not mandatory, the relative velocity between the gas streams and the grain particles exceeds a predetermined value.

According to still a further embodiment of the invention, the gas heat source is coupled to the mixture chamber through four gas ducts arranged for providing a first pair of hot gas streams run in a horizontal plane and a second pair of hot gas streams run in vertical plane. The hot gas streams in each pair of the streams are provided alternatively and directed in opposite directions. The ratio of the operation times before switching between the first pair of hot gas streams and the second pair of hot gas streams can be in the range of about 0.2 to 10.

The hot gas streams can provide spinning particles of the raw grain and circulating the particles along an inner surface of the chamber. Therefore, the technique of the present invention can provide uniform heating of the grain particles along the particle's surface and intensive heat exchange in the grain treatment process. According to the invention, the temperature of the gas in the hot gas stream is in the range of 100° C.-700° C.

Thus, in accordance with one broad aspect of the invention, there is provided a method of treatment of raw grain particles into a mixture chamber, characterized by providing in said mixture chamber at least two hot gas streams being configured for spinning the grain particles and circulating the grain particles along an inner surface of the mixture chamber.

In accordance with another broad aspect of the invention, there is provided a method of conversion of grain nutrients of raw grain particles treated in a mixture chamber to the condition in which said grain nutrients are readily digestible by a living organism, characterized by providing in said mixture chamber at least two hot gas streams being configured for spinning the grain particles and circulating the grain particles along an inner surface of the mixture chamber.

According to yet another broad aspect of the present invention, there is provided a grain product prepared by treating raw grain particles into a mixture chamber, characterized by providing ill said mixture chamber at least two hot gas streams being configured for spinning the grain particles and circulating the grain particles along an inner surface of the mixture chamber.

The present invention according to yet another broad aspect provides an apparatus for treatment of raw grain particles, comprising:

a mixture chamber in which said raw grain particles are provided;

a gas heat source; and

a blower fan for providing a hot gas flow through at least two gas ducts coupling said gas heat source to said mixture chamber, the gas ducts being equipped with nozzles at their ends for providing at least two hot gas streams being configured for spinning the grain particles and circulating the grain particles along an inner surface of the mixture chamber.

There has thus been outlined, rather broadly, the more important features of the invention in order that the detailed description thereof that follows hereinafter may be better understood. Additional details and advantages of the invention will be set forth in the detailed description, and in part will be appreciated from the description, or may be learned by practice of the invention.

### BRIEF DESCRIPTION OF THE DRAWINGS

In order to understand the invention and to see how it may be carried out in practice, preferred embodiments will now be described, by way of non-limiting example only, with reference to the accompanying drawings, in which:

FIG. 1 is a cross-sectional view of an apparatus for grain treatment, according to one embodiment of the invention;

FIG. 2 is a perspective view showing a cross-section of a portion of an apparatus of the invention shown in FIG. 1; and

FIG. 3 is a top view of a cross-section of a portion of the apparatus through line I-I and parallel to the XY-coordinate plane of FIG. 2;

FIG. 4, a cross-section in the XY-coordinate plane of a portion of an apparatus for grain treatment is illustrated, according to another embodiment of the present invention.

FIG. 5 is a perspective view of a cross-section of a portion of an apparatus for grain treatment, according to yet a further embodiment of the invention; and

FIG. 6 is a perspective view of a cross-section of a portion of an apparatus for grain treatment, according to still a further embodiment of the invention.

### DETAILED DESCRIPTION OF THE INVENTION

The principles and operation of the method and apparatus for raw grain treatment according to the invention may be better understood with reference to the drawings and the accompanying description, it being understood that these drawings are given for illustrative purposes only and are not meant to be limiting. The same reference numerals will be utilized for identifying those components which are common in the apparatus and its parts shown in the drawings throughout the present description of the invention.

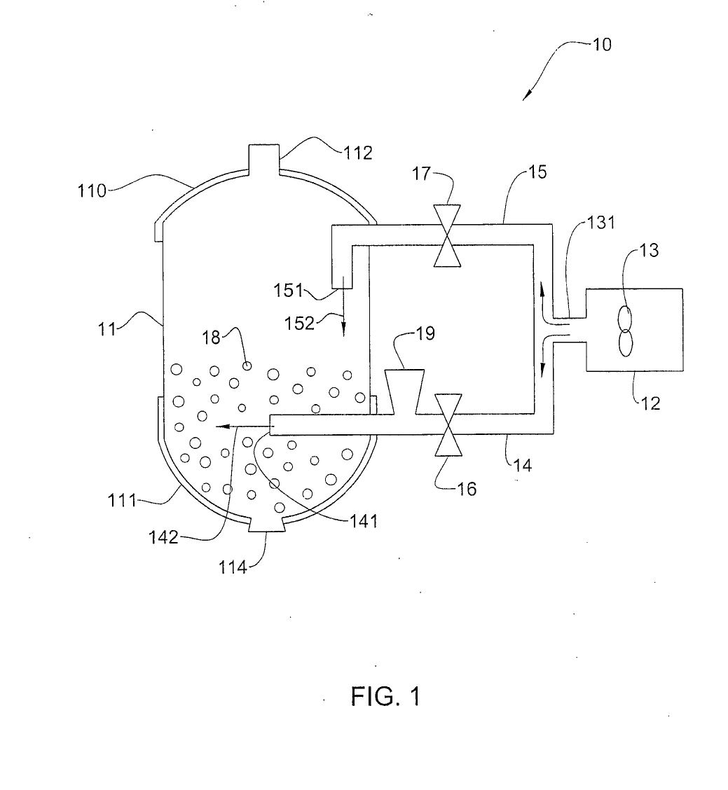

Referring to FIG. 1, a cross-sectional view of an apparatus 10 for grain treatment, according to one embodiment of the invention is illustrated. The apparatus 10 includes a mixture chamber 11 having a substantially cylindrical casing. Preferably, the casing of the mixture chamber 11 has semi-spherical top and bottom portions 110 and 111. The apparatus 10 further includes a gas heat source 12, a first gas duct 14 and a second gas duct 15, and a blower fan 13 for providing a hot gas flow through a gas manifold 131 the ducts 14 and 15. Valves 16 and 17 are located in the first gas duct 14 and the second gas duct 15, respectively, for controlling the velocity of the hot gas flowing therethrough. The first gas duct 14 at its end portion is equipped with a nozzle 141 for providing a first hot gas stream indicated by the arrow 142. At the end portion of the second gas duct 15 a nozzle 151 is provided for allowing a second hot gas stream indicated by the arrow 152. An outlet or exhaust port 112 is located at the top portion 110 of the mixture chamber 11 for conducting excessive gas out of the mixture chamber 11 when gas pressure in the mixture chamber 11 reaches a predetermined value. An example of the gas suitable for the purpose of the invention is air collected from the atmosphere and heated by the gas heat source 12. The first and second hot gas streams are streams of hot gas having temperature in the range of about 100° C. to 700° C.

Grain 18 can be fed into the mixture chamber 11 by various ways. According to the example shown in FIG. 1, the grain 18 is fed into the mixture chamber 11 through the first gas duct 14 mixed together with the flow of the first hot gas stream 142. For this purpose, a feed-hopper 19 is arranged within the first gas duct 14 for introducing the grain into the duct 14. The mixture chamber 11 includes a removal outlet 114 arranged at the bottom portion 111 for discharge of o the treated grain product.

It should be appreciated that the grain 18 can also be fed into the mixture chamber 11 through the second gas duct 15 with the flow of the second hot gas stream 152. In such a case, a feed-hopper (not shown) is provided within the second gas duct 15. Yet alternatively, a feed-hopper can be arranged at the top portion 110 of the mixture chamber 11.

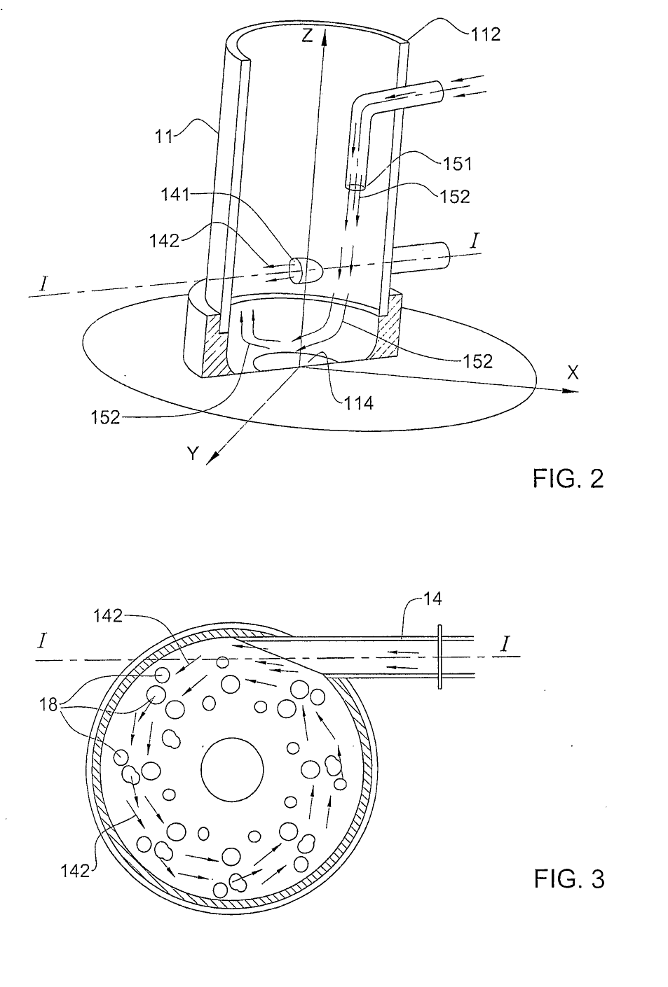

FIG. 2 illustrates a perspective view showing a cross-section of a portion of the apparatus shown in FIG. 1. The nozzle 141 is configured in such a manner that the first hot gas stream 142 is directed substantially tangentially to an inner surface of the mixture chamber 11 and runs parallel to the XY coordinate plane. The first hot gas stream 142 provides a horizontal component of the grain motion.

FIG. 3 shows a top view of a cross-section of a portion of the apparatus through I-I of FIG. 2. According to the invention, the first hot gas stream 141 (carrying the grain 18) has such velocity that it can swirl in the mixture chamber 11, and thereby provide intensive circulation of the gas-grain mixture in the horizontal plane parallel to the XY coordinate plane. Because of the circulation, the centrifugal forces can push the grain product in grain-gas mixture to the inner surface of the mixture chamber 11.

During the circulation, particles of the grain 18 participate in a complex motion. In particular, owing to numerous collisions of the particles to each other and to the inner surface of the mixture chamber 11, each individual particle participates, inter alia, in a circulation motion in the coordinate system associated with the mixture chamber and in a spin motion in the coordinate system associated with the particle. These two types of motion of the grain particle can be carried out simultaneously. Therefore, the technique of the present invention can provide more uniform heating of the grain particles along the particle's surface and more intensive heat exchange in the grain treatment process than, for example, in the aforementioned fluidized bed method, which does not provide the spinning of the grain particles. Indeed, since the grain particles in the fluidized bed method practically do not spin (when the gas passes through the bed), one side of the grain particle, which faces the gas flow, usually receives more heat than the opposite side of the particle. As a result, a non-uniform heating of the grain is obtained that does not provide complete heat treatment of the grain. The time extension of the treatment cannot always provide the required treatment result, since the particle side which faces the gas flow can sometimes be overheated and even burnt, while the opposite side does not yet receive required heat treatment.

Turning back to FIG. 2, the nozzle 151 is configured in such a manner that the second hot gas stream 152 is directed substantially tangentially to an inner surface of the mixture chamber 11 and runs parallel to the Z-coordinate axis. The second hot gas stream 152 provides a vertical component of the circulation grain motion (in addition to the horizontal component which is provided by the first gas stream 142). As a result of the combination of the flows associated with the first hot gas stream 142 and that the second hot gas stream 152, the trajectory of the motion of the grain particles will depend on the ratio of the velocities of the streams 142 and 152 and on the shape of the inner surface of the casing 11. The technique of the invention provides a slip of the particles along the combined gas flow. This effect is, inter alia, due to the fact that the radius of the circulation of the grain particles changes during their motion from the bottom portion 111 to the top portion 110. This feature also facilitates the uniformity and intensity of the heat exchange between the gas flow and the surface of the grain particles. Although the embodiment of the apparatus shown in FIGS. 1 and 2 has been described wherein the direction of the first hot gas stream 142 is substantially perpendicular to the direction of the second hot gas stream 152, it should be understood that a configuration of the apparatus wherein a desired angle between the directions of the streams 142 and 152 can also be implemented.

Moreover, in the technique of the present invention, the intensity of the heat exchange between the gas flow and the surface of the grain particles can be significantly higher than in the aforementioned fluidized bed method. Gas to particle heat transfer coefficient in the fluidized bed method is relatively small, of the order of 5 W/m² ° C.-20 W/m² ° C. It will be shown below that in the technique of the present invention, this coefficient is substantially greater than that in the fluidized bed method.

The heat transfer coefficient h from gas to particle can be estimated by utilizing a known relationship (see, for example, J. P. Holman, “Heat transfer,” McGraw-Hill Book Company, 1989, p. 295).

$$Nu = \frac{hD}{{K}_{a}} , \qquad ( 1 )$$

where Nu is the Nusselt number, Kₐ is the thermal conductivity coefficient of the gas and D is the particle's diameter. For calculation of the Nusselt number a known empirical relationship valid for a turbulent flow can be used (see, for example, J. P. Holman, “Heat transfer,” McGraw-Hill Book Company, 1989, p. 295)

Nu=2+(0.25+3·10⁻⁴Re^{1/6})^{1/2}, (2)

where Re is the single particle Reynolds number defined as

$$Re = \frac{{V}_{g} D}{v} , \qquad ( 3 )$$

where V_{g} is the relative velocity between the gas flow and the particle and ν is the kinematic viscosity of the gas.

The relative velocity between the gas and the particle is

V_{g}=u_{g}−uₚ, (4)

where u_{g} and uₚ are the velocities of the gas flow and the particle, respectively. The gas velocity can, for example, be estimated by using the following equation

u_{g}=Q/S, (5)

where Q is the consumption of the gas flowing through the fan (13 in FIG. 1) and S is the cross-sectional area of the mixture chamber (11 in FIG. 1), which is S=πa²/4, where d is the diameter of the chamber.

For the calculation of the parameters defined by Eqs, (1)-(5) the following numerical values of the physical parameters were selected:

Q=1100 liters/min;

d=0.053 m;

uₚ)=0.3 m/s;

u_{g}=8.3 m/s;

D=5·10⁻³ m;

Kₐ=5·10⁻² W/m° C. (at the temperature of 400° C.); and

ν=63.03·10⁻⁶ m²/s (at the temperature of 400° C.).

By using these parameters, the single particle Reynolds number, the Nusselt number and the gas to particle heat transfer coefficient are calculated as follows:

Re=634; Nu=5; and h=52 W/m² ° C.

As can be appreciated, according to the technique of the present invention, the value of the gas to particle heat transfer coefficient is 3-10 times greater than that in the fluidized bed method. It can be understood that this enhanced intensity of the heat exchange between the gas and the grain particles is associated, inter alia, with the relatively great values of the Reynolds and Nusselt numbers.

It should be appreciated that the uniformity of the heating together with the high intensity of the heat exchange between the gas and the grain particles can provide effective conversion of the grain nutrients to the condition in which they are readily digestible by animals. Such conversion of the nutrients can be carried out substantially without destroying valuable proteins having important nutritional properties. In addition, as will be shown hereinbelow, the apparatus and method of the present invention can substantially reduce the time required for grain treatment.

Moreover, the apparatus and method of the present invention allow for controlling the intensity of the heat exchange between the gas and the grain particles in accordance with the requirements of the nutritional properties of the grain product. The control can be achieved by varying, inter alia, gas temperature, gas velocity, configuration of the mixture chamber (11 in FIG. 1) and the angle between the direction of the first hot gas stream 142 and the direction of the second hot gas stream 152. It will be also shown hereinbelow an implementation of the apparatus and method in which the heat exchange between the hot air and the grain particles is controlled by variation of the relative velocity V_{g}. between the gas flow and the grain particles.

In the following, a non-limiting example of implementation of the technique of the invention in a pilot plant apparatus based on the embodiment shown in FIGS. 1-3 is illustrated.

### EXAMPLE

This example was carried out by using the pilot apparatus according to the embodiment shown in FIGS. 1-3 that has the characteristics shown in Table 1.

TABLE 1

| | | |
|---|---|---|
| Diameter of the mixture chamber 11 | 53 | mm |
| Height of the mixture chamber 11 | 160 | mm |
| Diameter of the fan manifold 131 | 14 | mm |
| Gas temperature at the fan manifold 131 | 400° | C. |
| Gas temperature at the outlet 112 | 275° | C. |
| Mass of the charging grain | 12 | g |
| Temperature of the charging grain | 20° | C. |
| Temperature of the discharged grain after treatment | 125° | C. |

The analysis of the composition of the soybeans shows that after the treatment over 13 seconds the amount of trypsin inhibitors in the soybeans decreases from 9.5 trypsin inhibitor units (TI units) to 3.8 TI units. In other words, the amount of the trypsin inhibitors in soybeans has a substantially smaller value for the soybean grain treated in the apparatus of the present invention. On the other hand, the analysis of the fat amount and the amino acid compositions of the untreated soybeans and those treated in the apparatus of the present invention indicates no significant difference in the amount of the fat and important amino acids, before and after the treatment.

One of the most important parameters of the method and apparatus for grain treatment is grain treatment time. It determines both the quality of the treated grain (e.g., reduction of antitrypsin agents without harming the amino acids) and economic features of the method and apparatus, i.e., the apparatus throughput and treatment cost. As can be appreciated by a person versed in the art, the time of the grain treatment depends on the heat transfer coefficient h that in turn can be characterized by the Nusselt number Nu (see Eq. (1)). As can be understood from Eqs. (2)-(4), one of the factors affecting the Nusselt number is the relative velocity V_{g} between the gas flow and the particle. The higher the relative velocity V_{g} the greater the Reynolds and Nusselt numbers Re and Nu and, as a consequence, the shorter the treatment time.

It should be understood that the maximal heat exchange is provided when a velocity up of the grain particle equals zero with respect to the apparatus, while the minimal heat exchange occurs when the absolute values of velocities of the particles and gas flow coincide, i.e., u_{g}=uₚ that results in V_{g}=0. Therefore, in order to intensify the heat exchange process, the relative velocity V_{g} should be maintained at high achievable values.

The above conclusion can be confirmed by mathematical modeling. In particular, the dynamic behavior of the grain particle can be described as a problem of motion of a particle under viscous force and gravity. A mathematical model of the particle movement is described by Sobolev et al in the paper published in Surface and Coatings Technology, 1994, V. 63, PP. 181-187. The equation of motion of a spherical particle in a viscous flow can be represented by

duₚ/dt=¾[C_{D}ρ_{g}/(Dρₚ)](u_{g}−uₚ)|u_{g}−uₚ| (6)

where D is the particle's diameter, ρ_{g} and ρₚ are the densities of the gas and the particle, respectively, and C_{D} is the drag coefficient. The drag coefficient C_{D} can be estimated by:

C_{D}=(23.707/Re)[1+0.165Re^{2/3}−0.5Re^{-0.1}] (7)

From the physical point of view, the particle accelerates owing to the viscous friction between the particle and the viscous gas flow. By solving Eq. (6), the time variation of the particle velocity can be obtained by

uₚ=u_{g}+(uₚ₀−u_{g})exp[−17.78(1+0.165Re^{2/3}−0.5Re^{-0.1}]μt/(ρₚD²), (8)

where uₚ₀ is the initial particle velocity, μ is the gas dynamic viscosity.

It should be noted that Eq. (8) together with Eqs. (2)-(4) can be used for calculation of the heat transfer coefficient h from the air to the particle.

The calculations have been done for soybean particles of various sizes. The following physical properties of the air and soybean were selected:

Air density at 400° C.: ρ_{g}=0.53 kg/m3,

Air heat conductivity coefficient at 400° C. : K_{g}=0.05 W/m° C.,

Density of soybean grains: Pₚ=753 kg/m3,

Specific heat capacity at constant pressure: Cₚ=1950−2300 J/(kg K),

Thermal conductivity coefficient of soybean grains: Kₚ=0.25−0.059 W/m K.

The calculation results are presented in Table 2.

TABLE 2

| | | | | Particle | Heat |
|---|---|---|---|---|---|
| Particle | Air | Particle | Relative | Travel | transfer |
| diameter | velocity | velocity, | velocity, | Time | coefficient |
| D, mm | u_{g}, m/s | uₚ, m/s | V_{g}, m/s | t, s | h, W/m²K |
| 6 | 8 | 0 | 8 | 0 | 60.1 |
| 6 | 8 | 2 | 6 | 1 | 52 |
| 6 | 8 | 4 | 4 | 3.2 | 36 |
| 6 | 5 | 0 | 5 | 0 | 39.8 |
| 6 | 5 | 1.25 | 3.75 | 1.4 | 35.2 |
| 6 | 5 | 2.5 | 2.5 | 4.3 | 30.4 |
| 4 | 8 | 0 | 8 | 0 | 61.4 |
| 4 | 8 | 2 | 6 | 0.6 | 54.2 |
| 4 | 8 | 4 | 4 | 1.8 | 46.5 |
| 4 | 5 | 0 | 5 | 0 | 50.4 |
| 4 | 5 | 1.25 | 3.75 | 0.8 | 45.5 |
| 4 | 5 | 2.5 | 2.5 | 2.44 | 49 |

As can be seen from Table 2, for the grain particles having equal dimensions the heat exchange coefficient is greater when the relative velocity V_{g} is higher. In other words, the heat exchange between the hot air and the grain particles can also be controlled by variation of the relative velocity V_{g}.

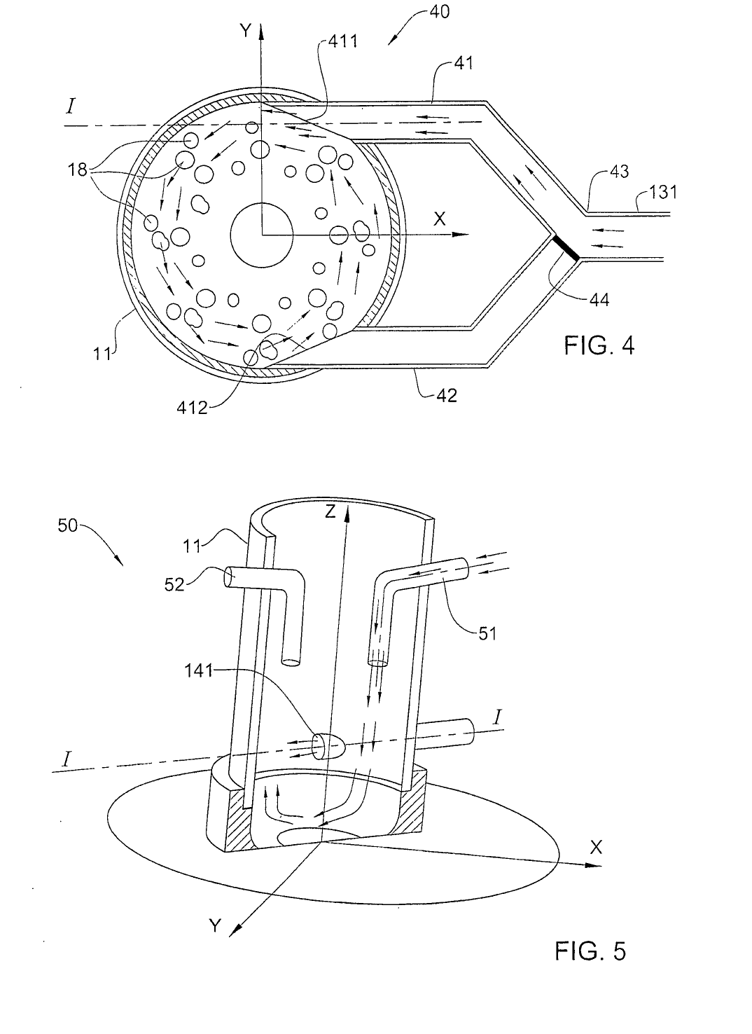

Referring to FIG. 4, a cross-section in the XY-coordinate plane of a portion of an apparatus 40 for grain treatment is illustrated, according to another embodiment of the present invention. The apparatus of this embodiment differs from the apparatus of FIG. 3 in the fact that it includes two gas ducts for providing hot gas streams substantially in the XY-coordinate plane (i.e., horizontal plane). Specifically, the apparatus 40 includes a first horizontal gas duct 41 and a second horizontal gas duct 42 having nozzles 411 and 412 at their ends, configured to provide alternatively two corresponding hot gas streams having opposite directions. For example, the nozzles 411 and 412 can be arranged at diametrally opposite sides of the mixture chamber 11. Preferably, each of these two gas streams is directed substantially tangentially to the inner surface of the mixture chamber 11 and runs parallel to the XY-coordinate plane. The first horizontal gas duct 41 and the second horizontal gas duct 42 are fed with a hot gas through a flow divider 43 connected to the fan manifold 131. A divider valve 44 (preferably of butterfly type) is arranged in the flow divider 43 and configured to direct the gas flow alternatively in the first or second horizontal gas ducts.

At the beginning of operation, the divider valve 44 is arranged such that the hot gas flow is directed only through one of the horizontal gas ducts, e.g. through the first horizontal gas duct 41. The grain particles 18, which are fed in the mixture chamber 11, will accelerate in their circulation motion from substantially zero value of velocity, uₚ=0, to a certain predetermined value uₚ₀. This predetermined value uₚ₀ is selected such that a relatively large magnitude of V_{g} will be sufficient to maintain effective heat exchange process during the acceleration stage of the particles. When the particle velocity uₚ reaches the value of uₚ₀ the divider valve 44 is switched so that the air flow will be directed through the second horizontal gas duct 42. Then, the process of the grain treatment continues during the circulation of the grain particles in the reverse direction until the particle velocity uₚ reaches the value of uₚ₀, and then the flow switches back to the first switches horizontal gas duct 41, etc. Such inversion of the gas flow will result in the increasing of the relative velocity V_{g} again to the value of the air flow velocity or even higher, because the grains will travel by inertia over a certain time period in the direction opposite to the direction of the switched air flow. It should be understood that in the suggested treatment the particle velocity uₚ will never reach its maximal value equal to the gas flow velocity. In other words, the relative velocity V_{g} can be maintained at rather high values.

This concept can be also applied to the vertical hot air streams. FIG. 5 illustrates a perspective view of a cross-section of a portion of an apparatus 50 for grain treatment, according to yet a further embodiment of the invention. The apparatus 50 differs from the apparatus 10 shown in FIG. 2 in the fact that it includes two gas ducts for providing gas streams substantially in parallel to Z-coordinate axis (i.e., arranged in a vertical plane). Specifically, the apparatus 50 includes a first vertical gas duct 51 and a second vertical gas duct 52 configured to provide alternatively two corresponding vertical hot gas streams within the mixture chamber 11 having opposite directions. Preferably, each of these two gas streams is directed substantially tangentially to the inner surface of the mixture chamber 11 and runs parallel to the Z-coordinate axis. For this purpose, the first vertical gas duct 51 and the second vertical gas duct 52 are equipped with nozzles 511 and 512 at their ends arranged, for example, at diametrally opposite sides of the mixture chamber 11.

The operation of the apparatus 50 for providing vertically directed air streams is similar to the embodiment described above for horizontally directed air streams. In particular, the hot air flow is alternatively supplied through the first vertical gas duct 51 or the second vertical gas duct 52, in order to maintain rather high relative velocity V_{g} between the air flow and the grains particles, and thereby enhancing the heat exchange process. It should be understood that such enhancement can result in higher throughput of the treatment apparatus, and can male the treatment cheaper owing to energy saving.

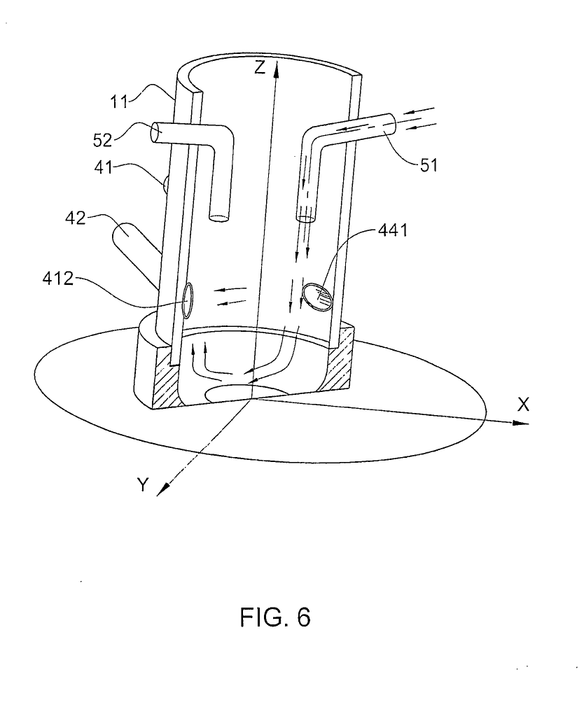

Referring to FIG. 6, when required an apparatus 60 for grain treatment can include two gas ducts for providing hot gas streams substantially in the XY-coordinate plane and two gas ducts for providing gas streams substantially in parallel to Z-coordinate axis. Specifically, the apparatus 60 includes the first horizontal gas duct 41 and the second horizontal gas duct 42 configured to provide alternatively two corresponding horizontal hot gas streams having opposite directions along with the first vertical gas duct 51 and the second vertical gas duct 52 configured to provide alternatively two corresponding vertical hot gas streams having opposite directions. It should be understood that switching of the gas flow between the horizontal ducts 41 and 42 and the vertical ducts 51 and 52 can be with different periodicity, that can provide even faster heat exchange, due to the breaking of the particle trajectories. For example, the ratio of the operation times before switching between the vertical and horizontal channels can vary from about 0.2 to 10, and more specifically from about 0.5 to 2.

As such, those skilled in the art to which the present invention pertains, can appreciate that while the present invention has been described in terms of preferred embodiments, the concept upon which this disclosure is based may readily be utilized as a basis for the designing of other devices and processes for carrying out the several purposes of the present invention.

Although the example of utilization of the apparatus of the present invention was shown for grain treatment, the apparatus can also be used for drying any powder and granular materials.

It should be appreciated that the apparatus and method of the present invention can be used as a part of the process of soybean oil production, e.g., for reduction of antitrypsin agents without harming the amino acids.

Also, it is to be understood that the phraseology, and terminology employed herein are for the purpose of description and should not be regarded as limiting.

It is important, therefore, that the scope of the invention is not construed as being limited by the illustrative embodiments set forth herein. Other variations are possible within the scope of the present invention as defined in the appended claims and their equivalents.

1. A method of treatment of raw grain particles into a mixture chamber, characterized by providing in said mixture chamber at least two hot gas streams being configured for spinning the grain particles and circulating the grain particles along an inner surface of the mixture chamber.

2. The method of claim 1 wherein the two hot gas streams are arranged tangentially to the surface of said mixture chamber.

3. The method of claim 1 wherein the two hot gas streams impinge on each other.

4. The method of claim 1 wherein the two hot gas streams are arranged at a predetermined angle to each other.

5. The method of claim 1 wherein the two hot gas streams are substantially perpendicular to each other.

6. The method of claim 1 wherein the two hot gas streams are provided alternatively and directed in opposite directions.

7. The method of claim 6 wherein each gas stream of said least two hot gas streams is such that the relative velocity between the gas streams and the grain particles exceeds a predetermined value.

8. The method of claim 6 further characterized by providing another two hot gas streams operating alternatively and directed in opposite directions.

9. The method of claim 8 wherein the ratio of the operation times before switching between said at least two hot gas streams and said another pair of hot gas streams is in the range of about 0.2 to 10.

10. The method of claim 1 wherein the two hot gas streams are streams of hot gas having temperature in the range of about 100° C. to 700° C.

11. The method of claim 1 wherein said treatment is carried out over a predetermined period of time sufficient for conversion of the grain nutrients to the condition in which they are readily digestible by a living organism, where the conversion of the nutrients being carried out substantially without destruction of valuable proteins having important nutritional properties.

12. A grain product prepared by the method of claims 1.

13. A grain product prepared by the method of claims 2.

14. A grain product prepared by the method of claims 3.

15. A grain product prepared by the method of claims 4.

16. A grain product prepared by the method of claims 5.

17. A grain product prepared by the method of claims 6.

18. A grain product prepared by the method of claims 7.

19. A grain product prepared by the method of claims 8.

20. A grain product prepared by the method of claims 9.

21. A grain product prepared by the method of claims 10.

22. A grain product prepared by the method of claims 11.

23. A method of conversion of grain nutrients of raw grain particles treated in is a mixture chamber to the condition in which said grain nutrients are readily digestible by a living organism, characterized by providing in said mixture chamber at least two hot gas streams being configured for spinning the grain particles and circulating the grain particles along an inner surface of the mixture chamber.

24. An apparatus for treatment of raw grain particles, comprising:
a mixture chamber in which said raw grain particles are provided;
a gas heat source; and
a blower fan for providing a hot gas flow through at least two gas ducts coupling said gas heat source to said mixture chamber, the gas ducts being equipped with nozzles at their ends for providing at least two hot gas streams being configured for spinning the grain particles and circulating the grain particles along an inner surface of the mixture chamber.

25. The apparatus of claim 24 wherein the two hot gas streams are arranged tangentially to the surface of said mixture chamber.

26. The apparatus of claim 24 wherein the two hot gas streams impinge on each other.

27. The apparatus of claim 24 wherein the two hot gas streams are arranged at a predetermined angle to each other.

28. The apparatus of claim 24 wherein the two hot gas streams are substantially perpendicular to each other.

29. The apparatus of claim 24 wherein the two hot gas streams are provided alternatively and directed in opposite directions.

30. The apparatus of claim 24 wherein each gas stream of said at least two hot gas streams is such that the relative velocity between the gas streams and the grain particles exceeds a predetermined value.

31. The apparatus of claim 24 wherein the two hot gas streams are run in a horizontal plane.

32. The apparatus of claim 24 wherein the two hot gas streams are run in a vertical plane.

33. The apparatus of claim 24 wherein said gas heat source is coupled to said mixture chamber through four gas ducts arranged for providing a first pair of hot gas streams run in a horizontal plane and a second pair of hot gas streams run in vertical plane.

34. The apparatus of claim 33 wherein the hot gas streams in each pair of the streams are provided alternatively and directed in opposite directions.

35. The apparatus of claim 33 wherein the ratio of the operation times before switching between said first pair of hot gas streams and said second pair of hot gas streams is in the range of about 0.2 to 10.

36. The apparatus of claim 24 wherein said at least two hot gas streams are streams of hot gas having temperature in the range of about 100° C. to 700° C.

37. The apparatus of claim 24 comprising a feed-hopper being arranged within one of the gas ducts for feeding the raw grain particles into said mixture chamber through the corresponding gas duct.

38. The apparatus of claim 24 comprising a feed-hopper being arranged on a top portion of said mixture chamber.

39. The apparatus of claim 24 wherein said mixture chamber includes an outlet for conducting excessive gas out of the mixture chamber.

40. The apparatus of claim 24 wherein said mixture chamber includes a removal outlet for discharge of the grain being treated.
